(19) United States
(12) Patent Application Publication
(10) Pub. No.: US 2009/0055128 A1
(43) Pub. Date: Feb. 26, 2009

(54) BURN-IN TEST SYSTEM FOR PROJECTION DEVICE

(75) Inventor: JIAN-SHENG ZHOU, Foshan (CN)

Correspondence Address: PCE INDUSTRY, INC.;ATT. CHENG-JU CHIANG, 458 E. LAMBERT ROAD, FULLERTON, CA, 92835, US

(73) Assignees: PREMIER IMAGE TECHNOLOGY(CHINA) LTD., Foshan City (CN); HON HAI PRECISION INDUSTRY CO., LTD., Tu-Cheng (TW)

(21) Appl. No.: 12/024,951

(22) Filed: Feb. 1, 2008

(30) Foreign Application Priority Data
Aug. 22, 2007 (CN) 200710201429.7

(51) Int. Cl. G06F 11/30

(52) U.S. Cl. 702/182

(57) ABSTRACT

A burn-in test system for a plurality of projection devices includes a plurality of light sensing modules, a data collecting module, a data receiving module, and a data processing module. Each of the light sensing modules is configured for receiving light from the respective projection device and converting the light into an electrical signal. The data collecting module is configured for converting the electrical signals from the light sensing modules into a plurality of digital signals and transmitting the digital signals. The data receiving module is configured for receiving the digital signals from the data collecting module. The data processing module is configured for processing the digital signals provided from the data receiving module to obtain age information of the projection devices.

### FIELD OF THE INVENTION

The present invention relates to a burn-in test system, and more particularly, relates to a burn-in test system for testing a large number of projectors.

### BACKGROUND

Burn-in/aging testing is one of the most important processes conducted to ensure reliability of projection devices such as digital light processing (DLP) projectors, or liquid crystal display (LCD) projectors. Conventionally, this test is carried out by manual inspection. However, such a manual inspection is an inefficient use of manpower and resources for such a batch process, and may do harm to the inspector (both the elevated test temperature, and gas from broken mercury lamps of failed projection devices are harmful to human beings).

Therefore, it is desirable to provide a burn-in test system for projection devices, which can overcome the above mentioned problems.

### SUMMARY

A burn-in test system for a plurality of projection devices includes a plurality of light sensing modules, a data collecting module, a data receiving module, and a data processing module. Each of the light sensing modules are configured for receiving light from a corresponding one of the projection devices and converting the light into a plurality of electrical signals. The data collecting module is configured for transforming the electrical signals from the light sensing modules into a plurality of digital signals and transmitting the digital signals. The data receiving module is configured for receiving the digital signals from the data collecting module. The data processing module is configured for processing the digital signals provided by the data receiving module to obtain age information of the projection devices.

### BRIEF DESCRIPTION OF THE DRAWINGS

Many aspects of the present burn-in test system can be better understood with reference to the following drawings. The components in the drawings are not necessarily drawn to scale, the emphasis instead being placed upon clearly illustrating the principles of the present burn-in test system. Moreover, in the drawings, like reference numerals designate corresponding parts throughout the several views.

FIG. 1 is a functional diagram of a burn-in test system according to an exemplary embodiment.

FIG. 2A is a schematic, front view of the light sensing module of FIG. 1.

FIG. 2B is a schematic, cross-sectional view of the light sensing module taken along line IIB-IIB of FIG. 1.

FIG. 3 is a functional diagram of the data collecting module of FIG. 1.

FIG. 4 is a schematic view showing the burn-in test system of FIG. 1 in use.

### DETAILED DESCRIPTION OF THE EMBODIMENTS

Embodiments of the present burn-in test system will be described in detail below with reference to the drawings.

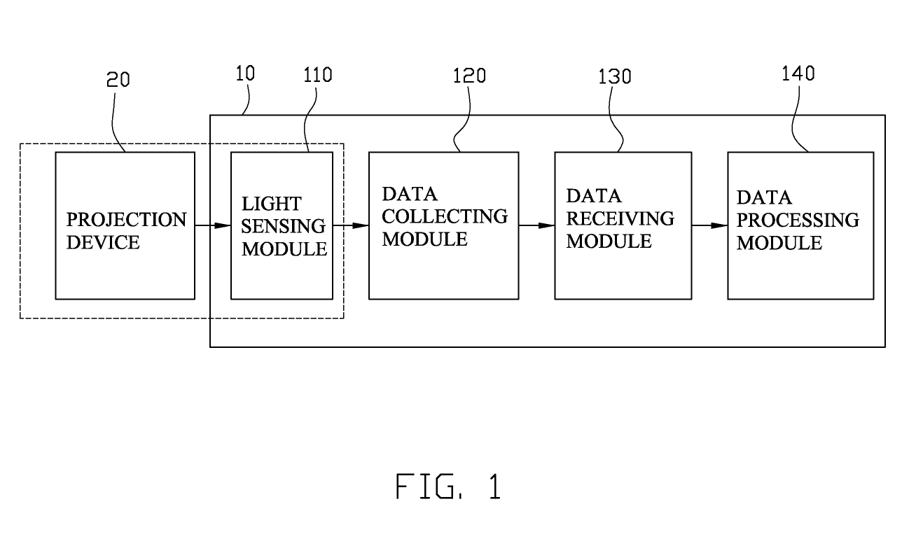

Referring to FIG. 1, a burn-in test system 10 for testing a large number of projection devices 20 includes a number of light sensing modules 110 each associated with one of the projection devices 20 respectively, a data collecting module 120, a data receiving module 130, and a data processing module 140. The light sensing module 110 and the projection devices 20 are accommodated in an enclosed room, represented by the dashed line of FIG. 1, to prevent outside influence of test conditions.

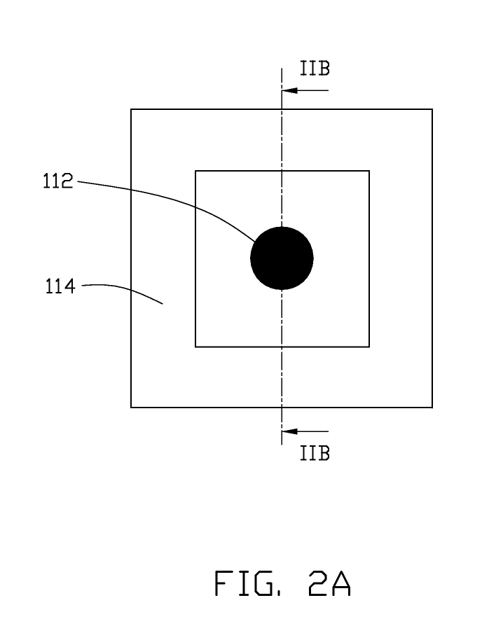

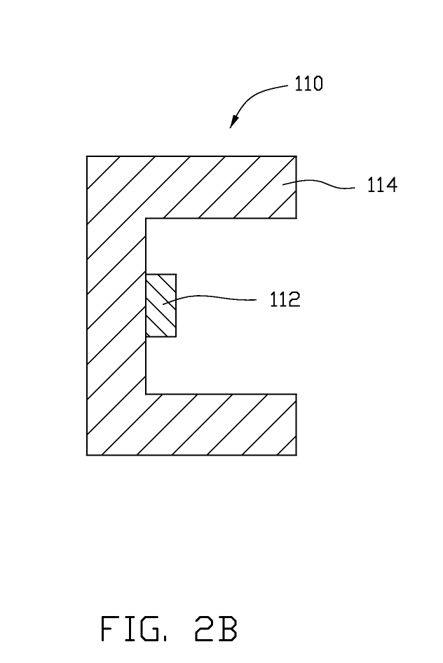

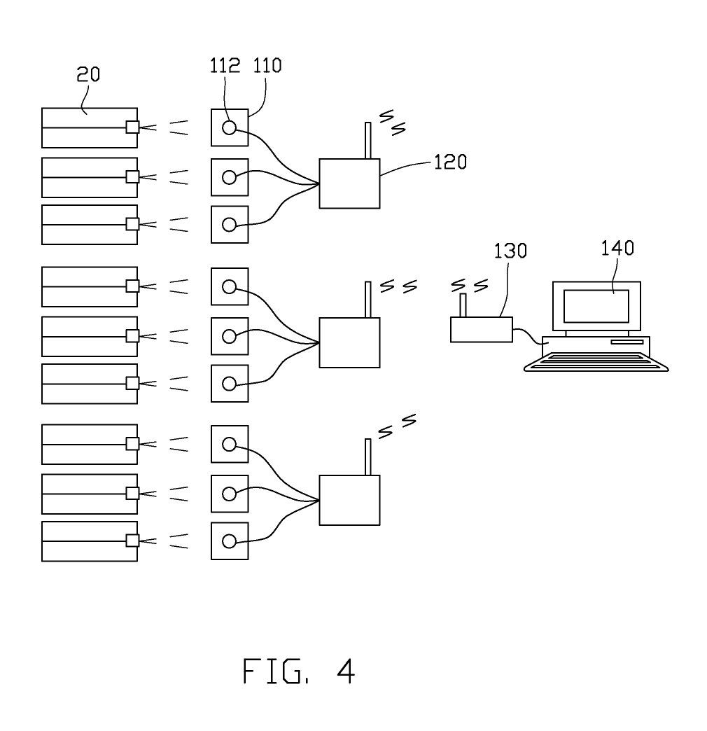

The light sensing module 110 is set facing a lamp of the corresponding projection device 20 (shown in FIG. 4) so as to receive light from the lamp and is configured to transform the received light into electrical signals indicative of the light intensity of the lamp (which correlates with the service time of the projection device). Various photosensitive sensors such as photosensitive resistors can be employed as the light sensing module 110. Referring to FIGS. 2A-2B, the light sensing module 110 of this embodiment includes a photosensitive resistor 112, and a receiver 114. The receiver 114 facing the lamp of the corresponding projection device 20 defines a receiving portion that is configured for collecting light from the lamp (shown in FIG. 4), and the photosensitive resistor 112 in the receiver 114 is set for receiving the light (shown in FIG. 4) and converting the light into the electrical signals.

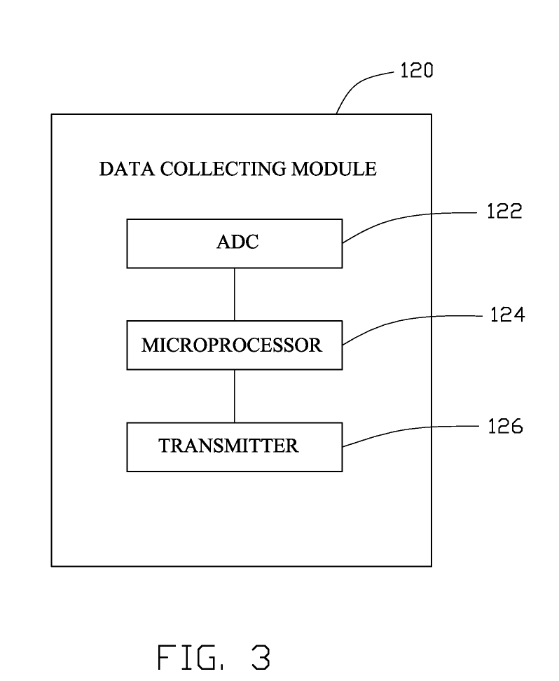

Referring to FIG. 3, the data collecting module 120 is configured for receiving the electrical signals from the light sensing modules 110 (shown in FIG. 1) and converting the electrical signals into digital signals. In detail, the data collecting module 120 includes an analog to digital converter (ADC) 122, a microprocessor 124, and a transmitter 126. The ADC 122 is configured for converting the electrical signals into the digital signals. The microprocessor 124 is set for processing the digital signals from the ADC 122 to provide age information of the projection device. The transmitter 126 can be a wireless transmitter, and is configured for transmitting the processed digital signals to the data receiving module 130 (shown in FIG. 4).

The data receiving module 130 is configured for receiving the processed digital signals. In this embodiment, the data receiving module 130 is a companion receiver to the transmitter 126.

The data processing module 140 is configured for processing the digital signals from the data receiving module 130 to cause the age information of the tested projection devices 20 to be displayed on a display device (shown in FIG. 4). In this embodiment, the data processing module 14 is a host of a computer, and the display device is a monitor of the computer. Thereby, inspectors can inspect the age information of the tested projection devices 20 outside the enclosed room.

FIG. 4 is a schematic view showing the burn-in test system 10 of FIG. 1 in use. For example, the burn-in test system 10 for the age information of the projection devices 20 includes nine sensing modules 110, three data collecting modules 120, a data receiving module 130, and a data processing module 140. Each of the light sensing modules 110 includes a photosensitive resistor 112 and is set facing the lamp of the corresponding projection device 20 so as to receive light from the respective projection device 20 and is for transforming the received light into electrical signals. Each of the data collecting modules 120 is electrically connected with the corresponding light sensing modules 110, and set for transforming the electrical signals into the digital signals. The data receiving module 130 is configured for receiving the processed digital signals transmitted from the data collecting modules 120. The data processing module 140 is electrically connected to the data receiving module 130 for receiving the processed digital signals and causing the age information of the projection device 20 to be displayed on the display device for the inspectors.

Compared with the related art, the present burn-in test system provides the light sensing module for receiving light from the light source of the corresponding projection device and blocking light from the other projection devices thus ensuring accuracy of the age information of the tested projection devices. The present burn-in test system can obtain the age information of the tested projection devices outside the enclosed room in real time for saving labor and decreasing costs.

It will be understood that the above particular embodiments are described and shown in the drawings by way of illustration only. The principles and features of the present invention may be employed in various and numerous embodiments thereof without departing from the scope of the invention as claimed. The above-described embodiments illustrate the scope of the invention but do not restrict the scope of the invention.

What is claimed is:

1. A burn-in test system for testing a plurality of projection devices each having a lamp for emitting light, comprising:
a plurality of light sensing modules configured for receiving and converting the light emitted from the plurality of respective projection devices into electrical signals;
a data collecting module configured for converting the electrical signals into digital signals and transmitting the digital signals;
a data receiving module configured for receiving the digital signals transmitted from the data collecting module; and
a data processing module configured for processing the digital signals provided from the data receiving module to obtain age information of the projection devices.

2. The burn-in test system as claimed in claim 1, wherein the light sensing modules faces the lamps of the respective projection devices.

3. The burn-in test system as claimed in claim 1, wherein each of the light sensing modules comprises:
a receiver facing a corresponding projection device configured for collecting the light emitted from the corresponding projection device; and
a photosensitive resistor in the receiver configured for receiving the light emitted from the corresponding projection device and converting the light into the electrical signals.

4. The burn-in test system as claimed in claim 1, wherein the receiver of the light sensing module is configured for receiving the light emitted from the corresponding projection device and blocking the light from the other of the plurality of projection devices.

5. The burn-in test system as claimed in claim 1, wherein the data collecting module comprises:
an analog-to-data converter configured for converting the electrical signals into the digital signals;
a microprocessor configured for processing the digital signals provided from the analog-to-digital converter to obtain the age information of the projection devices; and
a transmitter configured for transmitting the digital signals to the data receiving module.

6. The burn-in test system as claimed in claim 1, wherein the transmitter is a wireless transmitter.

7. The burn-in test system as claimed in claim 1, wherein the data processing module is a host computer with a display device.
